(19) United States
(12) Patent Application Publication
(10) Pub. No.: US 2001/0027100 A1
(43) Pub. Date: Oct. 4, 2001

(54) Method and system for implementing a service in a telecommunication system

(76) Inventors: Pekka Immonen, Lepsama (FI); Jukka Wallenius, Helsinki (FI)

Correspondence Address: Altera Law Group, 6500 City West Parkway - Suite 100, Minneapolis, MN, 55344-7701, US

(21) Appl. No.: 09/841,396

(22) Filed: Apr. 24, 2001

Related U.S. Application Data
(63) Continuation of application No. PCT/FI99/00906, filed on Oct. 28, 1999.

(30) Foreign Application Priority Data
Oct. 28, 1998 (FI) 982343

(51) Int. Cl. H04Q 7/20

(52) U.S. Cl. 455/422; 455/445

(57) ABSTRACT

Method for implementing a service in a telecommunication system comprising a mobile subscriber network, a mobile switching center connected to the mobile subscriber network and an intelligent network connected to the mobile subscriber network. In the method, the mobile switching center is provided with a service control function, which is connected via an A-interface to a call control protocol, an SSAP protocol and a call control function. Moreover, a message coming from a protocol is transmitted to the service control function, and call control is controlled by the service control function at the intelligent network interface and queries are made by the call control function to obtain information from the service control function, and instructions are received by the call control function from the service control function.

### FIELD OF THE INVENTION

The present invention relates to telecommunication. In particular, the present invention concerns a method and system for implementing a service in a telecommunication system.

### BACKGROUND OF THE INVENTION

With the development of mobile communication technologies, e.g. GSM technology, and intelligent network (IN) technology, the level of services provided by the public switched telephone network (PSTN) and public land mobile networks (PLMN) has risen considerably in recent years. The emergence of intelligent network technologies allows the introduction of new services even within a short term. Before, a problem with the introduction of new services was that possible software updates had to be implemented in many or almost all telephone exchanges or mobile switching centers (MSC).

With the intelligent network ideology, this problem has been partially eliminated. Some of the network components are “dumb” switching points which have no actual intelligence but are still capable of identifying certain triggering factors associated with intelligent network services, thus directing service setup to other components. Therefore, “dumb” components can be used without major changes, thus allowing considerably faster introduction of new services.

The problem is, however, that services associated with call control, such as standardized GSM supplementary services, are still mostly implemented as permanent features in conjunction with call control, i.e. most services are directly encoded in the call control logic of the switching center.

This will be a source of difficulties at the time of a future transition from standardized GSM supplementary services to a fully intelligent-network based service architecture. Specifically, there are plans according to which the service architecture of the Universal Mobile Telecommunication System (UMTS) will be completely based on intelligent network technologies and will not comprise any standardized supplementary services.

The object of the present invention is to eliminate the drawbacks referred to above or at least to significantly alleviate them. A specific object of the invention is to disclose a new type of method and system in which services associated with call control are not implemented as permanent elements of call control but instead as separate applications that use call control in a manner corresponding to intelligent network applications.

A further object of the invention is to disclose the use of call control and intelligent network interfaces in the implementation of standardized GSM supplementary services and especially a connection between a service control function (SCF) and the SSAP protocol (SSAP, Supplementary Services Application Part). SSAP is a protocol used in the GSM network between two home location registers (HLR) or, against an ISDN network (ISDN, Integrated Services Digital Network), between a home location register and an ISDN switching center to synchronize the states of the two queues—incoming and outgoing queues—in different network elements.

HLR is the home location register for a mobile station and it is used to store subscriber information, such as location data. Connected to a mobile switching center is also a visitor location register (VLR), to which e.g. essential subscriber information is copied from the home location register.

As for the features characteristic of the invention, reference is made to the claims.

### BRIEF DESCRIPTION OF THE INVENTION

The method of the present invention concerns the implementation of a service in a telecommunication system comprising a mobile subscriber network, a mobile switching center connected to the mobile subscriber network and an intelligent network connected to the mobile subscriber network. In the method, the mobile switching center is provided with a service control function, which is connected to the A-interface Call Control protocol, SSAP protocol and to a call control function, and a message received from a protocol is transmitted to the service control function and the call control function is controlled by the service control function at the intelligent network interface. In this context, A-interface refers to the interface between a mobile station and a mobile switching center. A Call Control protocol is a protocol used between a mobile switching center and a mobile station. The Call Control protocol used in the GSM system is RIL3-CC (RIL3-CC, Radio Interface Layer 3 Call Control). Moreover, in the method, the call control function is used to make queries and receive instructions from the service control function.

In a preferred embodiment of the present invention, a reference to the service control function is added to the call control triggering data if a standardized GSM supplementary service whose functions can be implemented utilizing the intelligent network interface is active for the subscriber. Triggering data means “triggers” used to direct a desired service call to an appropriate place. Such triggering data may consist of e.g. a given numeric sequence.

In a preferred embodiment of the invention, the message transmitted from the service control function to the call control function is based on a method or message of the call control function according to e.g. CS-2, CAMEL Phase 3 or AIN call party handling.

In a preferred embodiment of the present invention, at the beginning of a call, if any one of the standardized GSM supplementary services implemented via intelligent network interfaces is active for the subscriber, data for the triggering of intelligent network services are added to the subscriber information obtained from the VLR and to the call control function. In another preferred embodiment, the triggering data are only added when the call control function queries the VLR for subscriber information in the case of either an outgoing call or a terminating call. In the triggering data, it is possible to include information regarding call control events in which it is necessary to make a service control function query. Moreover, in an embodiment, the intelligent network interface for call control is an INAP interface.

The system of the invention for implementing a service in a telecommunication system comprises a mobile subscriber network, a mobile switching center connected to the mobile subscriber network and an intelligent network connected to the mobile subscriber network. The mobile switching center in the system of the invention is provided with a service control function. The service control function comprises means for controlling the call control function at the intelligent network interface. Moreover, the call control function comprises means for making queries and means for receiving instructions from the service control function.

In addition, the system comprises a home location register connected to the mobile switching center and a visitor location register connected to the mobile switching center. Further, the system of the invention comprises an intelligent network switching point connected to the mobile switching center of the mobile subscriber network and an intelligent network control point connected to the intelligent network switching point.

In a preferred embodiment of the invention, the mobile subscriber network is a digital land mobile network, e.g. a GSM network.

In a preferred embodiment of the invention, the service control function of the mobile switching center is an internal program block in the mobile switching center, whose interface to the call control function, to the A-interface call control protocol or SSAP protocol is based on the communication method used between the program blocks in the mobile switching center.

In a preferred embodiment of the invention, the service control function of the mobile switching center communicates with the mobile switching center via a Corba (CORBA, Common Object Request Broker Architecture) interface defined by OMG (Object Management Group). In this case, the connection with the call control, the A-interface call control protocol or the SSAP protocol is established via the Corba interface.

The invention makes it possible to once implement in call control a functional mechanism that can be utilized both in the switching center's own services and in intelligent network services. Moreover, the invention can be used to implement various present and future mobile network supplementary services.

### LIST OF ILLUSTRATIONS

In the following, the invention will be described in detail by the aid of examples of its embodiments, wherein

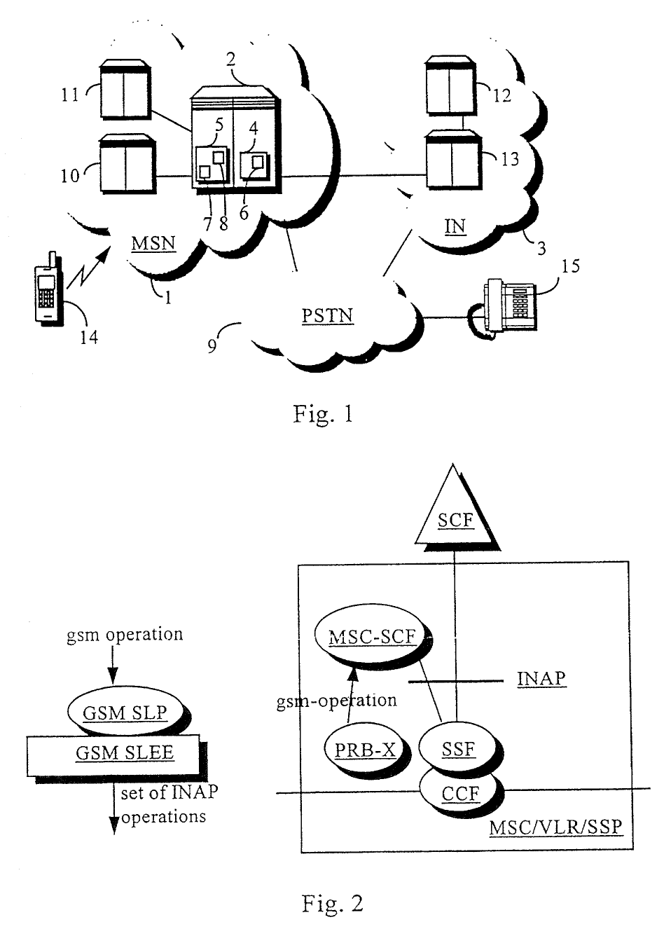

FIG. 1 presents a skeleton diagram showing the components of a mobile communication system utilizing an intelligent network that are essential with regard to the invention.

FIG. 2 presents a system according to the present invention,

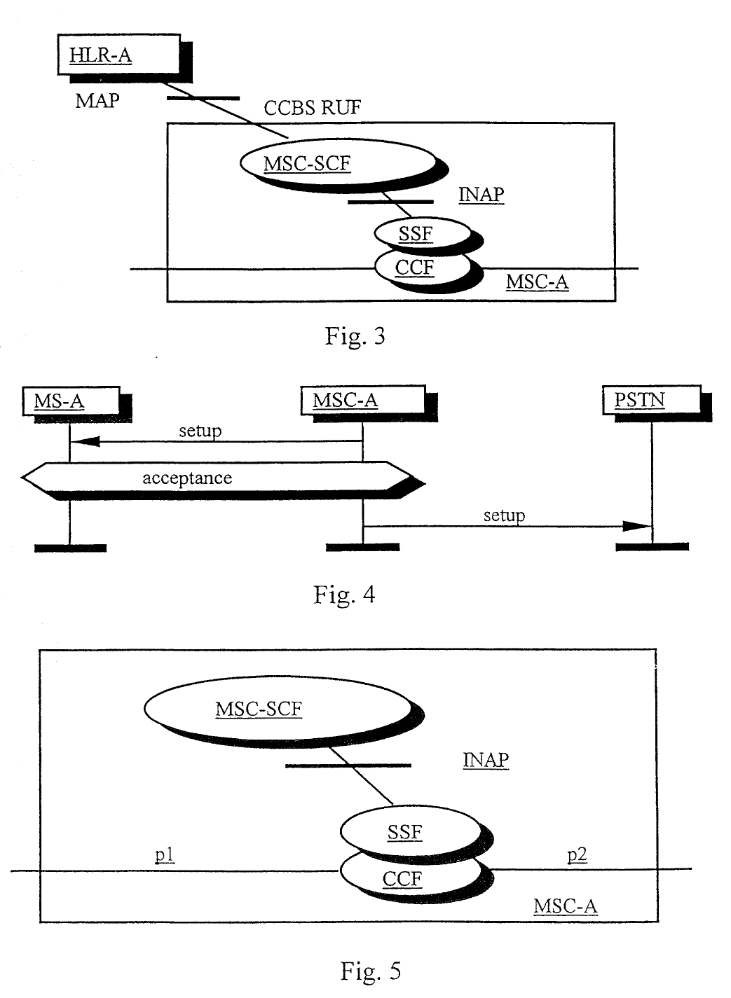

FIG. 3 presents an embodiment of the present invention as an example of a system for setting up a CCBS call (CCBS, Call Completion to Busy Subscriber) based on intelligent network architecture,

FIG. 4 presents an example of a flow diagram illustrating the use of a system as presented in FIG. 3 in the case of a CCBS call,

FIG. 5 presents an embodiment of the present invention as an example of a system for setting up a CCBS call based on intelligent network architecture,

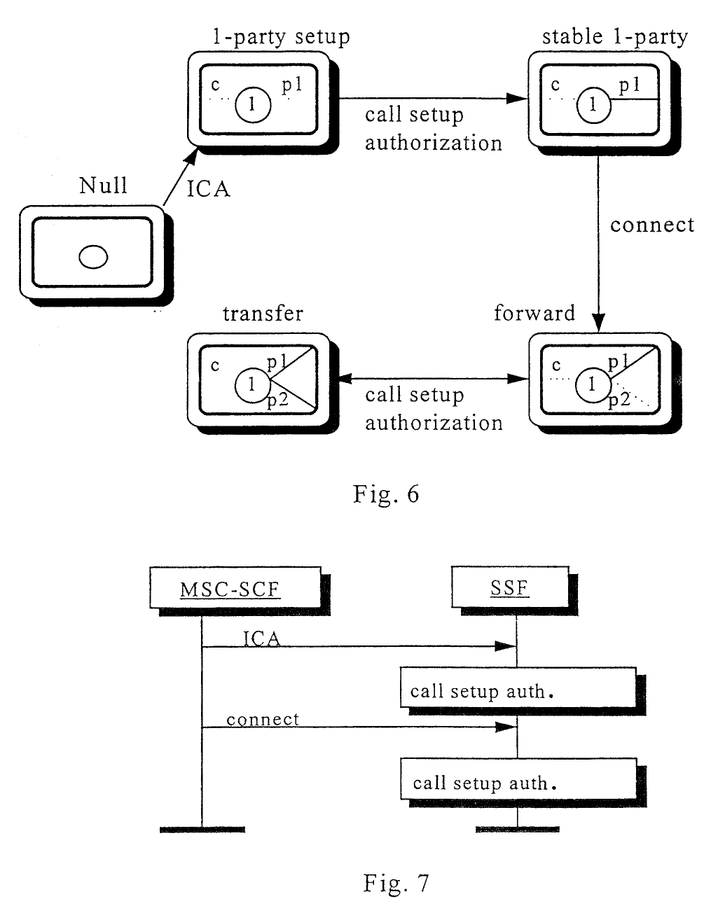

FIG. 6 presents a call setup chain in the case of a CCBS call,

FIG. 7 presents an example of a flow diagram illustrating the use of a system as presented in FIG. 5 in the case of a CCBS call,

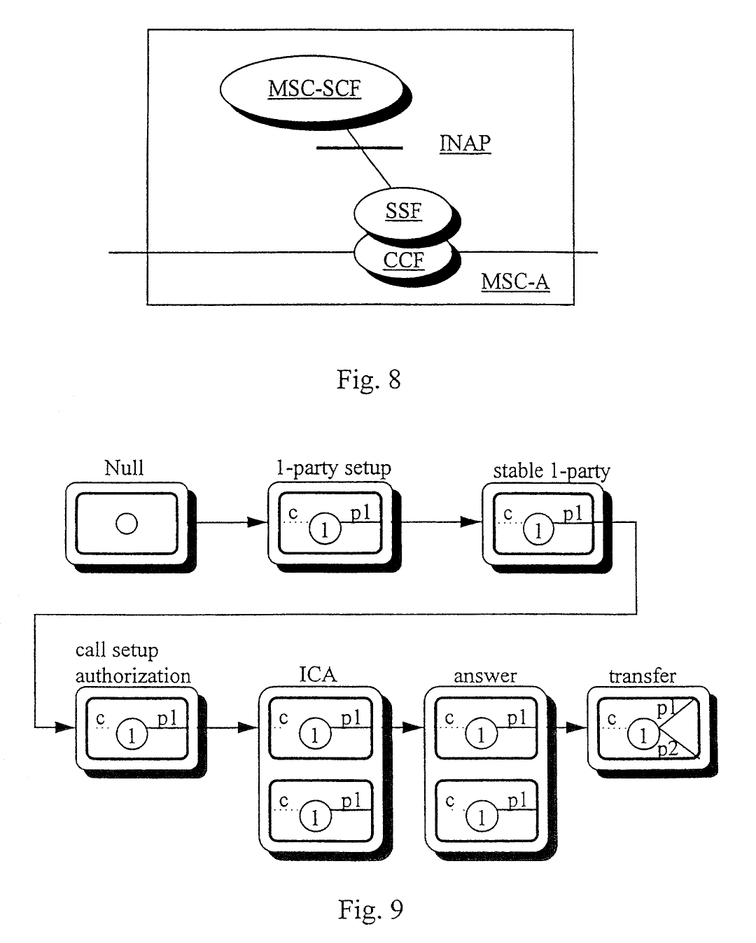

FIG. 8 presents an embodiment of the present invention as an example of a system for setting up a CCBS call based on intelligent network architecture,

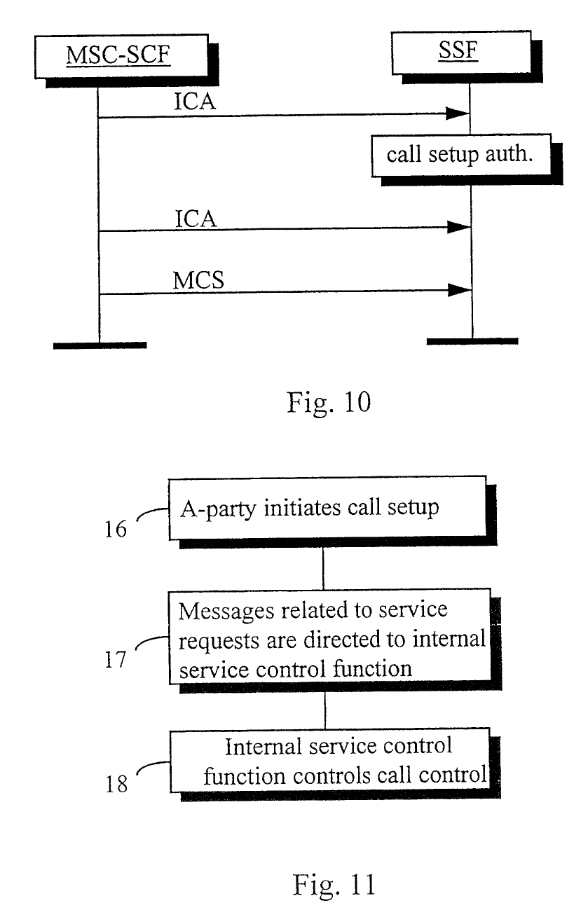

FIG. 9 presents a call setup chain in the case of a CCBS call,

FIG. 10 presents a flow diagram exemplifying the use of a system as presented in FIG. 8 in the case of a CCBS call, and

FIG. 11 presents an example of a flow diagram illustrating an embodiment of the invention.

### DETAILED DESCRIPTION OF THE INVENTION

FIG. 1 is a diagrammatic representation of a system according to the invention, comprising a mobile subscriber network 1 and an intelligent network 3 connected to it. Connected to the mobile subscriber network 1 is a mobile switching center 2. The mobile switching center 2 is provided with a separate service control function 4. Moreover, the mobile switching center comprises a call control function 5. The service control function 4 comprises means 6 for controlling the call control function 5 at the intelligent network interface. Further, the call control function 5 comprises means 7 for making queries to obtain information from the service control function 4 and means 8 for receiving instructions from the service control function 4. Connected to the mobile switching center 2 are also a home location register 10 and a visitor location register 11. Further, connected via a radio interface to the mobile switching center is a first telecommunication terminal 14, which in this example is a mobile station.

In this example, the intelligent network 3 comprises an intelligent network service switching point 12 (SSP) and an intelligent network service control point 13 (SCP) connected to the intelligent network service switching point 12. For the transfer of information between the SSP 12 and SCP 13, the INAP protocol (INAP, Intelligent Network Application Part) is used. INAP is a protocol stack connecting common channel signalling to an intelligent network.

Connected to the mobile subscriber network 1 and intelligent network 3 in this example is also a wired telephone network 9 (Public Switched Telephone Network). Further, connected to the wired telephone network 9 is a second telecommunication terminal 15.

Means 6-8 are implemented in a manner known in itself, e.g. as program blocks used by computer, and they will therefore not be described in detail.

FIG. 2 presents an embodiment of the system of the present invention according to FIG. 1. The system comprises an intelligent network control function SCF, which is connected via an INAP interface to an intelligent network service switching function (SSF). Connected to the service switching function SSF is also a call control function CCF. Also connected to the service switching function is the service control function of the mobile switching center MSC-SCF via the intelligent network interface. The MSC-SCF is operated by program block PRB X (PRB, ProgRam Block).

The GSM network service control function MSC-SCF consists of separate components GSM SLP (SLP, Service Logic Program) and GSM SLEE (SLEE, Service Logic Execution Environment) . The actual service logic is located in the SLP. The SLPs are run in a SLEE environment. The SLEE contains e.g. an operating system, external modules or program libraries. In a preferred embodiment of the invention, the SLEE is an execution environment based on Sun Microsystems Java language.

FIG. 3 presents a preferred embodiment of the system of the present invention. The system illustrated in FIG. 3 represents a system based on intelligent network architecture, designed to implement a CCBS service. The system comprises a home location register HLR A (HLR, Home Location Register), which communicates with the MSC-SCF via a MAP interface (MAP, Mobile Application Part). In addition, the system comprises an SSF and a CCF, which communicate with the MSC-SCF via an INAP interface. In this example, the MSC-SCF, SSF and CCF together form the mobile switching center MSC-A of the mobile subscriber network. A CCSB call begins when the HLR-A for the A-subscription announces that the B-party is on-hook. A CCBS RUF message (RUF, Remote User Free) indicates that the HLR for the B-party has reported that the B-party is free. The RUF message is transmitted via the HLR-A to the MSC-A, whereupon the MSC-A starts call setup from the A-party to the B-party. The MSC-SCF sets up a CCBS call by utilizing the CS-2 properties (CS-2, Capability Set 2) of the intelligent network.

FIG. 4 presents an example illustrating the operation of a system according to FIG. 3 in the case of a CCBS call. As shown in the figure, the MSC-A starts call setup to establish a call to MS-A (MS, Mobile Station). Once the call setup procedure has been successfully completed, the MSC-A sets up a speech connection to the B-party in a corresponding manner. In this example, the B-party is a subscriber in the wired telephone network PSTN.

FIG. 5 presents a preferred embodiment of the present invention as an example of the system of the invention. In this example, the CS-2 properties of the intelligent network are utilized. The system comprises an SSF and a CCF, which communicate with the MSC-SCF via an INAP interface. In this example, the MSC-SCF, SSF and CCF together form the mobile switching center MSC-A of the mobile subscriber network. Concepts p1 and p2 appearing in the figure signify A- and B-parties.

FIG. 6 presents a preferred example of a call setup scheme according to the present invention in conjunction with a CCBS call. In this example, the CS-2 properties of the intelligent network are utilized. The call is set up in a system as presented in FIG. 5. From the Null state, the network starts call setup ICA (ICA, InitiateCallAttempt) in the A-party's direction (1-party setup). Next, the A-party is authenticated (call setup authorization). When the A-party answers, the result is a stable 1-party state, whereupon call setup is continued in the B-party's direction. After the B-party has been authenticated, a call between the A- and B-parties can be established.

FIG. 7 presents an example of the operation of the system according to FIG. 5 in the case of a CCBS call. The CS-2 properties of the intelligent network are utilized in this example. Call setup is effected as in FIG. 6. The MSC-SCF starts call setup by sending an ICA message to the SSF. After the A-party has answered, the MSC-SCF inquires via a notice and collection of a DTMF selection whether the A-party accepts the call initiation. After the A-party has accepted the call initiation in the B-party's direction, the MSC-SCF starts call setup to the B-party by performing a connect operation. A connection between the A- and B-parties is established if the B-party answers.

FIG. 8 presents an example of a preferred embodiment of the system of the present invention. In this example, the CS-2 properties of the intelligent network are utilized. The system comprises an SSF and a CCF, which communicate with the MSC-SCF via an INAP interface. In this example, the MSC-SCF, SSF and CCF together form the mobile switching center MSC-A of the mobile subscriber network.

FIG. 9 presents a preferred example of operation according to the invention in conjunction with a CCBS call. In this example, the CS-2 properties of an intelligent network are utilized. The call is set up in a system as illustrated in FIG. 8. From the Null state, the network starts call setup in the direction of the A-party (1-party setup). After the A-party has answered, the state changes to a Stable 1-party state, whereupon the A-party accepts the call initiation. After this, a second call is initiated (ICA) in the direction of the B-party. After the B-party has answered (answer), these two calls are connected together via an MCS operation (MCS, MergeCallSegments), a transfer state being thus reached.

FIG. 10 presents an example of the operation of the system according to FIG. 8 in the case of a CCBS call. In this example, the CS-2 properties of an intelligent network are utilized. Call setup is effected in accordance with FIG. 9. The MSC-SCF starts call setup by sending an ICA message to the SSF. After the A-party has been authenticated (call setup auth.), the MSC-SCF starts call setup to the B-party by sending an ICA message to the SSF. The two calls are connected together when the MSC-SCF sends an MCS message to the SSF.

FIG. 11 presents a preferred example of a flow diagram representing the operation of the system of the invention. According to block 16, the A-party starts call setup by dialling a desired number. The telecommunication terminal used by the A-party is preferably a mobile station. In conjunction with the location updating procedure, the internal service control function examines the subscriber's service data obtained from the home location register HLR and, if any one of the above-mentioned services is active for the subscriber, changes the intelligent network triggering data to be stored in the visitor location register VLR and given to the call control function at the beginning of the call. The triggering data are changed by adding to them an indication of the events in call control function that require an internal control function query. In other words, if the numeric data selected by the A-party functions as a triggering factor, then call control is transferred to the internal service control function and messages related to service requests are directed to the internal service control function (block 17). The internal service control function controls the call control function by using the intelligent network interface for call control (block 18), thus taking care of implementing the desired service.

Let it be further stated that the invention has been mainly described with reference to the GSM system (GSM, Global System for Mobile communications) and using associated terms, but the invention can also be used or applied in some other mobile communication system.

The invention is not restricted to the examples of its embodiments described above, but many variations are possible within the scope of the inventive idea defined in the claims.

1. Method for implementing a service in a telecommunication system comprising a mobile subscriber network (1), a mobile switching center (2) connected to the mobile subscriber network (1) and an intelligent network (3) connected to the mobile subscriber network (1), characterized in that
the mobile switching center (2) is provided with a service control function (4), which is connected to an A-interface call control protocol, an SSAP protocol and a call control function (5);
a message coming from a protocol is transmitted to the service control function (4), and call control (5) is controlled by the service control function (4) at the intelligent network interface; and
queries are made by the call control function (5) to obtain information from the service control function (4), and instructions are received by the call control function (5) from the service control function (4).

2. Method as defined in claim 1, characterized in that a reference to the service control function (4) is added to the triggering data of the call control function (5).

3. Method as defined in claims 1 and 2, characterized in that the message transmitted from the service control function (4) to the call control function (5) is based on a method or message of the call control function (5) according to CS-2.

4. Method as defined in claims 1 and 2, characterized in that the message transmitted from the service control function (4) to the call control function (5) is based on a method or message of the call control function (5) according to CAMEL Phase 3.

5. Method as defined in claims 1 and 2, characterized in that the message transmitted from the service control function (4) to the call control (5) is based on a method or message of the call control function (5) according to AIN call party handling.

6. Method as defined in claims 1-5, characterized in that data for the triggering of intelligent network services are added to the subscriber information returned from the VLR to the call control function at the beginning of call setup if any one of the GSM supplementary services partially or completely implemented via an intelligent network interface is active for the subscriber in the VLR subscriber data.

7. Method as defined in claims 1-6, characterized in that an indication of those events in the call control function (5) in which it is necessary to make a service control function (4) query is added to the triggering data.

8. Method as defined in claims 1-7, characterized in that the intelligent network interface for call control (5) is an INAP interface.

9. System for implementing a service in a telecommunication system comprising a mobile subscriber network (1), a mobile switching center (2) connected to the mobile subscriber network (1) and an intelligent network (3) connected to the mobile subscriber network (1), characterized in that
the mobile switching center (2) is provided with a service control function (4);
the service control function (4) comprises means (6) for controlling the call control function (5) at the intelligent network interface;
the call control function (5) comprises means (7) for making queries and means (8) for receiving instructions from the service control function (4).

10. System as defined in claim 9, characterized in that the mobile subscriber network (1) is a digital mobile subscriber network.

11. System as defined in claims 9 and 10, characterized in that the mobile subscriber network (1) is a GSM network.

12. System as defined in claims 9-11, characterized in that the service control function (4) is an internal program block or other internal software component in the mobile switching center (2).

13. System as defined in claims 9-11, characterized in that the service control function (4) is a function connected to the mobile switching center (2) via a Corba interface.

14. System as defined in claims 9-11, characterized in that the service control function (4) is a Java-language execution environment.
